(19) United States
(12) Patent Application Publication
(10) Pub. No.: US 2007/0137256 A1
(43) Pub. Date: Jun. 21, 2007

(54) Methods for optical fiber manufacture

(76) Inventors: Eric L. Barish, Cumming, GA (US); Alan A. Klein, Duluth, GA (US); Fengging Wu, Duluth, GA (US)

Correspondence Address: Law Firm of Peter V.D. Wilde, 301 East Landing, Williamsburg, VA, 23185, US

(21) Appl. No.: 11/311,817

(22) Filed: Dec. 19, 2005

(51) Int. Cl. C03B 37/018

(52) U.S. Cl. 65/415

(57) ABSTRACT

The specification describes an improved VAD method wherein a multi-layer preform, with three or more layers of material having different refractive indices, are produced. The method involves the combination of tandem dual torch deposition, and multiple pass deposition, without consolidation between multiple passes.

### FIELD OF THE INVENTION

This invention relates to methods for manufacturing optical fibers, and to improved optical fiber preform fabrication techniques.

### BACKGROUND OF THE INVENTION

A variety of methods are known for making optical fiber preforms in the manufacture of optical fiber including, for example, Modified Chemical Vapor Deposition (MCVD), Sol-Gel, and Vapor Axial Deposition (VAD). The Modified Chemical Vapor Deposition (MCVD) method is a widely used approach for the manufacture of optical fibers. In this method, the preparation of the preform from which the optical fiber is drawn involves a glass working lathe, where pure glass or glass soot is formed on the inside of a rotating tube by chemical vapor deposition. An advantage of the MCVD method is that deposition of soot occurs inside the tube. This allows a high degree of control over the atmosphere of the chemical vapor deposition, and consequently over the composition, purity and optical quality of the preform glass. It also allows complex refractive index profiles to be fabricated by depositing soot of a first composition for a first layer, consolidating the first layer, depositing soot of a second composition, consolidating the second layer, and so forth. Several, or even many, layers can be produced in this way. The deposition/consolidation/deposition sequence succeeds in part because the interface between a consolidated layer, and the next soot layer is preserved in a near nascent state because of the atmospheric control mentioned above.

In the VAD method soot preforms are prepared by reacting glass precursors in an oxyhydrogen flame to produce silica particles. The silica particles are deposited on a starting rod. The starting rod is slowly pulled upward while it is rotated, and the silica particles are deposited axially on the rod as it is pulled. Very large, and long, soot preforms can be fabricated. Typically the soot for the core is produced by a core torch and the soot for the cladding by a cladding torch. In this way, the composition of the glass can be varied from the center portion of the perform to the outside portion. Variation in glass composition is required for providing the refractive index difference necessary to produce light guiding in the optical fiber.

However, in the VAD method the preform is prepared in an uncontrolled atmosphere, where water and other contaminates are present. There are a variety of techniques for controlling contamination in VAD processes, but these have proven inferior to the control inherent in MCVD methods. These methods typically involve purifying a deposited soot body, where the entire porous body is accessible to a vapor phase de-contaminant, such as chlorine. In the prior art, this has precluded the deposition, consolidation, deposition sequence mentioned above. In the VAD method, where the surface of a preform layer that has been consolidated is exposed to surface contaminates, efforts to de-contaminate the surface of a consolidated layer have met with limited success. Thus there remain persistent contaminants at the interface between a consolidated layer, and the next soot layer. One consequence of this is that VAD methods in general use just one or two soot deposition passes, prior to consolidation, and therefore do not produce the complex index profiles possible with MCVD methods.

### SUMMARY OF THE INVENTION

We have developed an improved VAD method wherein a multi-layer preform, with three or more layers of material having different refractive indices, are produced. The method involves the combination of tandem dual torch deposition, and multiple pass deposition, without consolidation between multiple passes.

### BRIEF DESCRIPTION OF THE DRAWINGS

FIG. 1 is a schematic representation of a conventional tandem two torch VAD process;

FIGS. 2 and 3 are schematic views of an embodiment with a two-element growth monitor using a laser extinction method;

FIG. 4 is a schematic representation of a two torch VAD process using multiple soot-forming passes according to the invention;

FIG. 5 is a table relating the VAD soot deposition represented in FIG. 4 to recommended processing conditions for the embodiment shown;

FIG. 6 is a plot showing the refractive index profile produced by the conditions shown in FIGS. 4 and 5;

FIGS. 7 and 8 are schematic representations of a rod-in-tube process for making a preform using a VAD core rod produced according to the embodiment shown in FIGS. 4-6; and

FIG. 9 is a schematic representation of a fiber drawing apparatus useful for drawing preforms, made by the invention, into continuous lengths of optical fiber.

### DETAILED DESCRIPTION

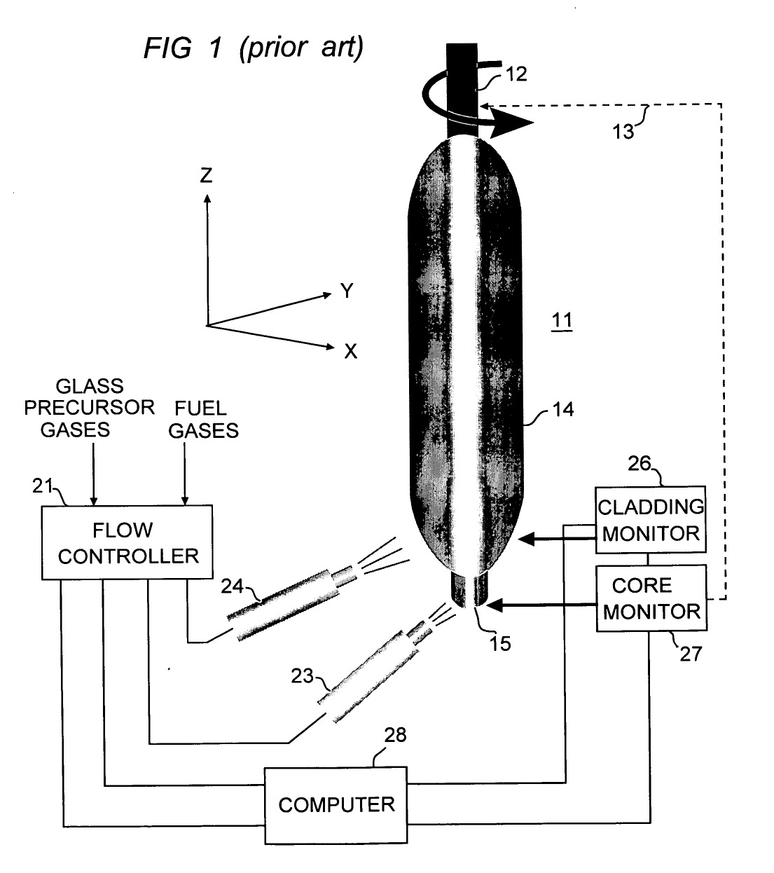

With reference to FIG. 1, a schematic arrangement for pulling a soot preform in a conventional VAD method is shown. The preform, shown generally at 11, is formed around a support rod 12. The rod is rotated during pulling as indicated by the arrow. The rotation minimizes x-y variations in the preform composition. The x-, y-, and z-axes are shown to the left of the preform. The preform comprises a cladding portion 14, and a core portion 15. The cladding is typically pure silica, or lightly doped silica. The core is typically silica, doped with germania. These combine to produce a preform with a refractive index difference between the core and the cladding. As is well known, the core and cladding may be made with a wide variety of compositions to produce many types of index profiles. For example, the core may be undoped and the cladding down-doped. More than one cladding layer may be made. However, in the most typical embodiment, the core is doped with germanium and the cladding is either undoped or doped with a lower concentration of germanium. Other dopants, such as phosphorus and fluorine may also be used. More details on the basic VAD process can be found in U.S. Pat. No. 6,928,841 issued Aug. 16, 2005, which is incorporated herein by reference.

Deposition of core soot is produced by torch 23 and deposition of cladding soot by torch 24. The torches are oxy-hydrogen torches with a flame fed by oxygen and hydrogen to control the temperature of the reaction zones in a known fashion. The two torches operate in tandem as shown, one following the other, so that the core soot is deposited first, followed by the cladding soot deposited on the core soot. The flow controller and the two torch assemblies also provides the supply of glass precursor gases to the reaction zones. The glass precursor gases typically comprise SiCl₄ and GeCl₄ in an inert carrier gas. The precursor gas may be only SiCl₄ if the preform profile calls for a pure silica core, or pure silica cladding. In a conventional VAD apparatus, the supply of precursor gases and fuel gases to the torches 23 and 24 is set according to the process specification. The pull rate is adjusted, according to variations detected at the tip location, by a core growth rate monitor similar to that shown at 27, but with the signal from the core growth rate monitor used, as indicated by feed-back loop 13 in FIG. 1, to adjust the pull rate. Reference to pulling the support rod 12 of FIG. 1 is meant to include any arrangement wherein the position of the preform is controllably moved in relation to the position of torches 23 and 24.

Improved control of the VAD process may be obtained by independently monitoring the growth rates of the core soot and the cladding soot. This may be implemented using independent monitors 26 and 27 for the cladding and core growth rates respectively. Any change in either is fed back to computer 28, which computes the control action sent to flow controlling unit 21. As just described, the flow controlling unit controls the flow of glass precursor gases to the reaction zones of both the core soot and the cladding soot, and controls the temperature of both reactions by controlling the flow of fuel gases to the torches 23 and 24. In the arrangement shown, control of the core soot and cladding soot reactions is independent, and may be implemented by controlling the flow rate of the precursor gases, the fuel gases, or both. This is described in more detail in U.S. Pat. No. 6,923,024, issued Aug. 2, 2005, which is incorporated by reference herein.

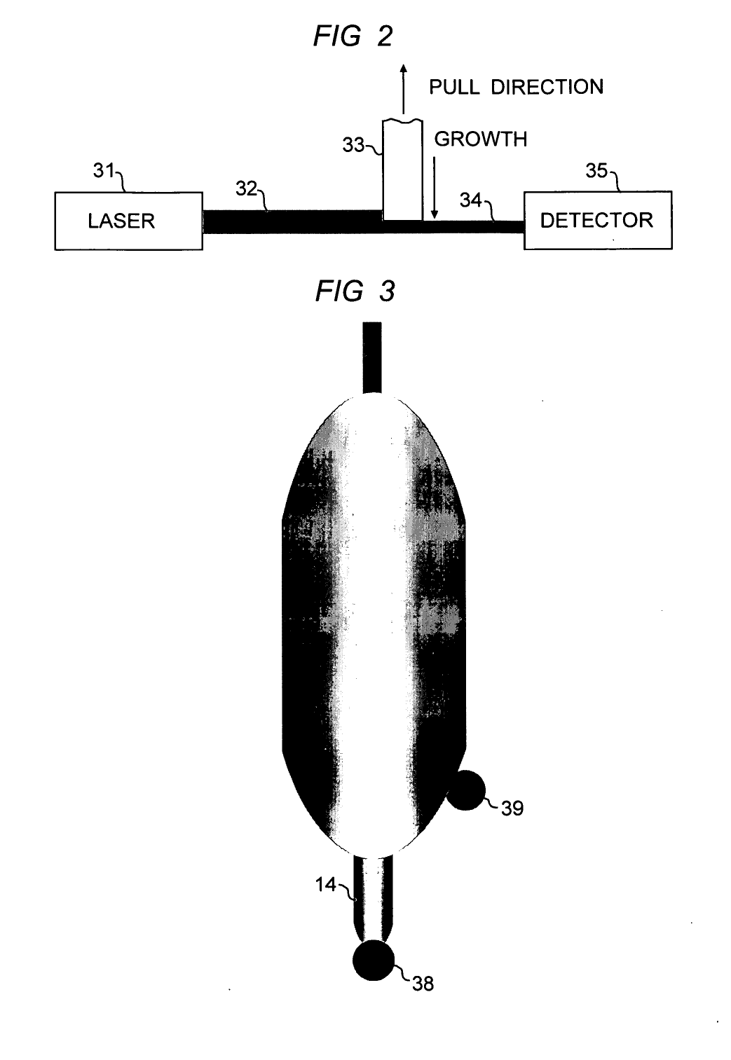

In one embodiment the growth rate of soot in the reaction zones is monitored using a laser beam extinction method. This is illustrated in FIG. 2, where monitoring laser 31 produces a beam 32, which is incident on the end of the core reaction zone where the core soot 33 is deposited. The beam is arranged so that it is partially obscured by the soot as it grows in the z-direction. The portion 34 of the laser beam that is not obscured passes to detector 35. Detector 35 controls the rate of pulling in the z-direction by maintaining a constant power level in beam 34. The extinction ratio can be set at any desired value. Assuming a circular laser beam, the power level variation with z-direction displacement is most sensitive if the extinction is near maximum or minimum. However, beam alignment is most reliable if the extinction ratio is near 50%, for example, 35%-65%. A beam extinction displacement monitoring system suitable for the invention is illustrated in FIG. 3. The monitoring beams, 38 and 39 for the core reaction zone and the cladding reaction zone, respectively, are shown, with the beam direction extending toward the viewer. Other axes may be chosen.

Complex refractive index profiles, intended in this discussion to mean preforms and fibers with at least three and typically four or more refractive index layers, are usually made using either MCVD, or a combination of fabrication methods including MCVD, OVD, VAD, and overcladding techniques. For example, core rods may be produced using VAD. Typically this will produce a core rod comprising an inner core and a first cladding layer. The core rod may then be used in a rod-in-tube process to incorporate additional cladding layers. VAD methods are used typically to produce one or two soot layers. In the two layer VAD method, two torches are used as described above. The two soot layers are then consolidated and used as the final preform, or used as a core rod to produce more complex profile preforms.

According to the invention, a VAD method is used to produce complex refractive index profiles as just discussed. In the method of the invention, the soot deposition phase of the method comprises at least two passes with at least two torches arranged in tandem. Soot to form the core and first cladding layer are produced on the first pass. Additional cladding layers are produced on the second pass. In the preferred embodiments, at least two tandem torches are used in at least two passes, thus producing a four-layer soot composite. Additional tandem torches and additional passes may be used to produce even more complex profiles.

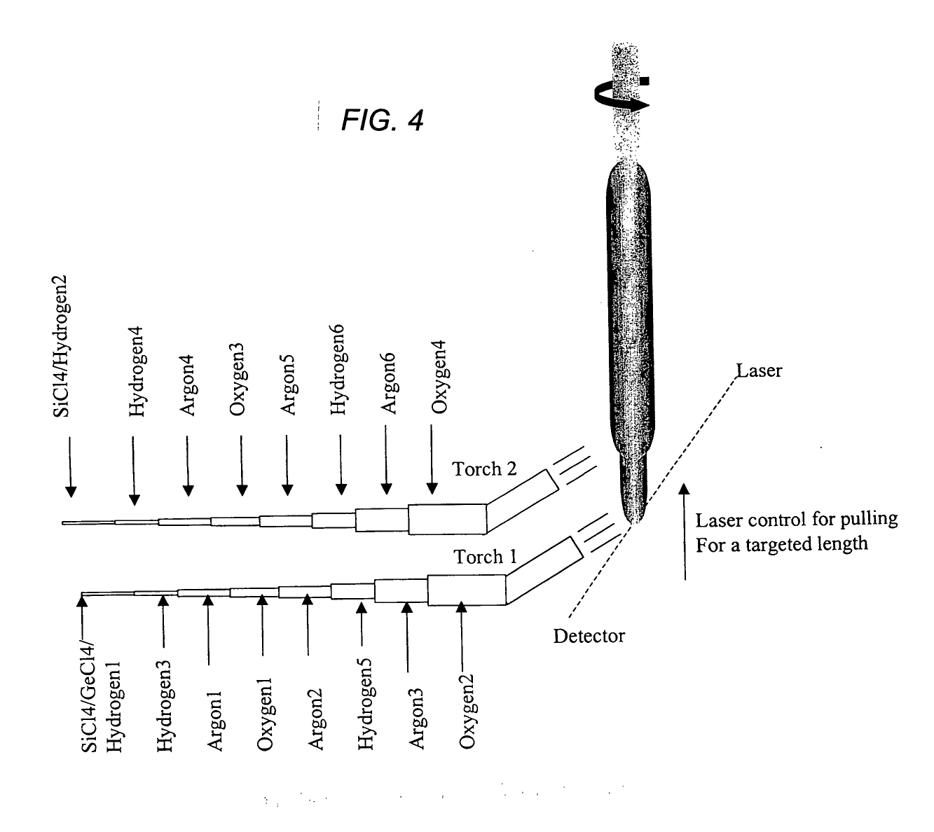

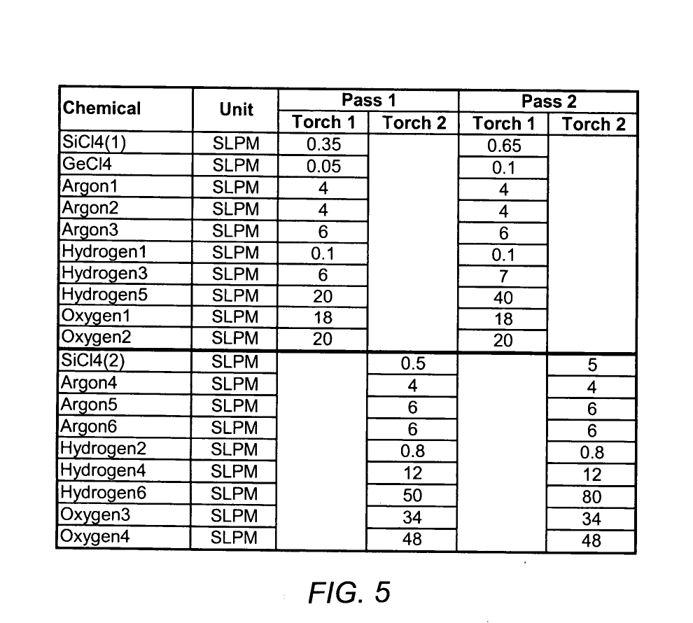

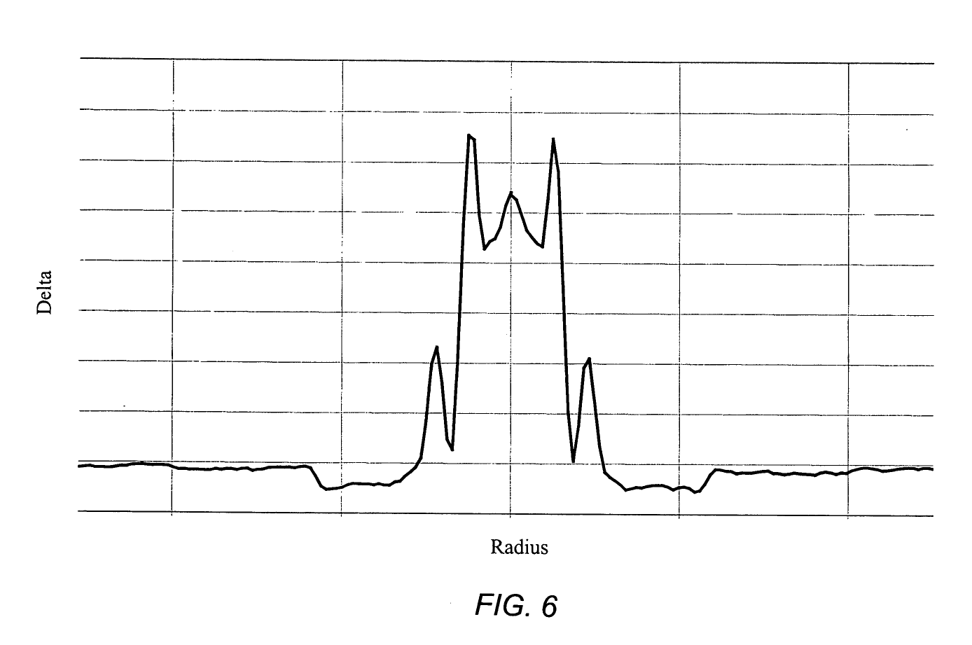

The multiple tandem torch/multiple pass method of the invention is represented schematically in FIGS. 4 and 5. FIG. 4 shows a process sequence for the multiple tandem torch soot deposition. The demonstration of the invention presented here is for producing a germanium doped core, surrounded by lower doped cladding. The cladding refractive index profile is complex, having four inflection points in the profile. The profile is shown in FIG. 6. This kind of complex profile is the result of using two passes of two tandem torches according to the schedule shown in FIG. 5. It cannot readily be produced by the conventional VAD method. The profile of FIG. 6 represents the index profile for both the preform and the optical fiber, so the radius dimension is not specific in the figure.

After deposition of the soot and formation of the porous soot preform, the porous body is then consolidated by heating to a temperature sufficient to sinter the silica particles into a solid, dense, glass preform. Consolidation is typically performed by heating the soot body to a temperature of 1400° C. to 1600° C. The solid preform is then ready for mounting in a fiber draw apparatus and drawing optical fiber, as will be discussed in more detail below.

The most demanding aspect of preform manufacture usually involves the formation of the core and the primary cladding. This is the region where composition changes are most critical, and control of the reaction temperature requires the most precision. The outside cladding may be made using other, less expensive, techniques. Thus it is conventional to employ a VAD method to form a rod with the core and primary cladding, then use the rod in a rod-in-tube method, as mentioned above to add additional cladding layers. An advantage of the invention is that the second phase of this two-phase process, i.e. the rod-in-tube phase, can be eliminated, and the whole profile produced using just a VAD phase.

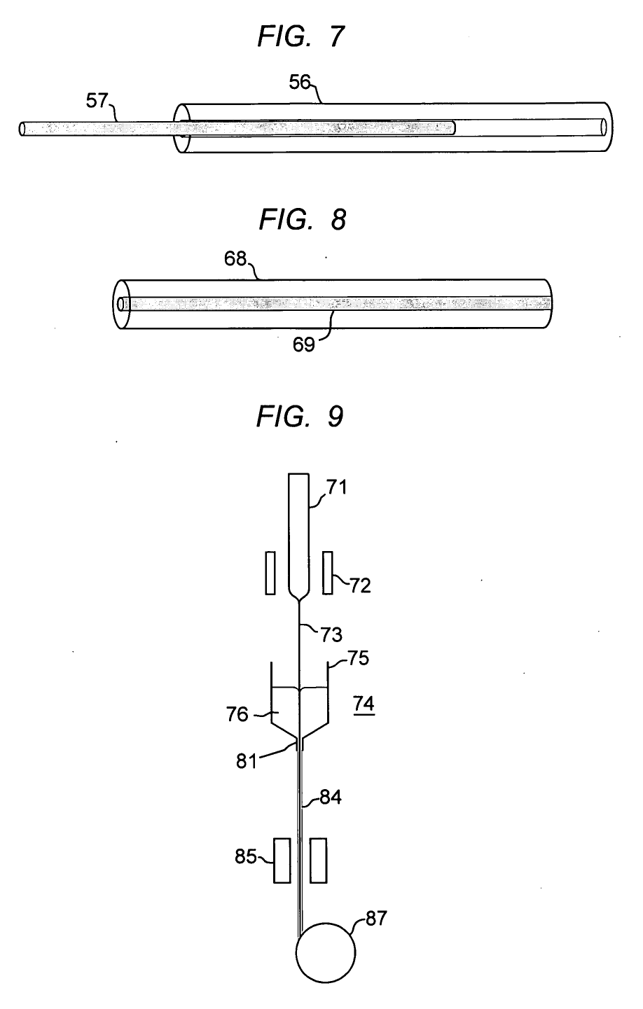

However, in some cases it may be desirable to use a rod-in-tube phase in addition to the VAD phase of the invention. A typical rod-in-tube approach is shown in FIGS. 7 and 8. The drawing is not to scale. The cladding tube is shown in FIG. 7 at 56. A typical length to diameter ratio is 10-15. The core rod 57 is shown being inserted into the cladding tube. The rod at this point is typically already consolidated. In an alternative overcladding method cladding soot is deposited on top of a core rod. There exist several common options for the composition of the core rod. It may be pure silica, with a down-doped cladding. It may have a pure silica center region with a down doped outer core region. It may have an up-doped, e.g. germania doped, center core region surrounded by a pure silica region. It may have an up-doped center core region surrounded by a down doped outer core region. All of these options are well known in the art and require no further exposition here. After assembly of the rod 57 and tube 56, the combination is sintered to produce the final preform 68 shown in FIG. 8, with the core 69 integral with the cladding but with a small refractive index difference.

Typical dimensions of the rod and cladding tube are also well known. The diameter of a consolidated cladding tube for a standard multi-mode fiber is approximately twice the diameter of the core rod. In the case of a preform for a single mode fiber the diameter of the rod is approximately 5% of the final diameter of the cladding tube.

The completed preform is then used for drawing optical fiber in the conventional way. FIG. 9 shows an optical fiber drawing apparatus with preform 71 and susceptor 72 representing the furnace (not shown) used to soften the glass preform and initiate fiber draw. The drawn fiber is shown at 73. The nascent fiber surface is then passed through a coating cup, indicated generally at 74, which has chamber 75 containing a coating prepolymer 76. The liquid coated fiber from the coating chamber exits through die 81. The combination of die 81 and the fluid dynamics of the prepolymer, controls the coating thickness. The prepolymer coated fiber 84 is then exposed to UV lamps 85 to cure the prepolymer and complete the coating process. Other curing radiation may be used where appropriate. The fiber, with the coating cured, is then taken up by take-up reel 87. The take-up reel controls the draw speed of the fiber. Draw speeds in the range typically of 1-20 m/sec. can be used. It is important that the fiber be centered within the coating cup, and particularly within the exit die 81, to maintain concentricity of the fiber and coating. A commercial apparatus typically has pulleys that control the alignment of the fiber. Hydrodynamic pressure in the die itself aids in centering the fiber. A stepper motor, controlled by a micro-step indexer (not shown), controls the take-up reel.

Coating materials for optical fibers are typically urethanes, acrylates, or urethane-acrylates, with a UV photoinitiator added. The apparatus in FIG. 9 is shown with a single coating cup, but dual coating apparatus with dual coating cups are commonly used. In dual coated fibers, typical primary or inner coating materials are soft, low modulus materials such as silicone, hot melt wax, or any of a number of polymer materials having a relatively low modulus. The usual materials for the second or outer coating are high modulus polymers, typically urethanes or acrylics. In commercial practice both materials may be low and high modulus acrylates. The coating thickness typically ranges from 150-300 μm in diameter, with approximately 240 μm standard.

Reference herein to silica preforms means highly pure silica bodies. The silica base material for optical fiber preforms necessarily excludes impurities such as water or iron. They may however, include small amounts of dopants, such as fluorine, for modifying refractive index. Typical optical fiber is more than 85% silica by weight.

Reference to pulling the support rod 12 of FIG. 1 is meant to include any arrangement wherein the position of the preform is controllably moved in relation to the position of torches 23 and 24. Either the support rod or the torches may be moved. These are equivalents in that the movement required is relative, so that movement of one or the other if stated means relative movement.

The term tandem is used herein to describe at least two torches that operate in tandem, i.e. one following the other, so that a first layer of soot is deposited first, followed by a second layer of soot deposited on the first layer of soot.

The description of multiple passes of the tandem torches means that a first bi-layer of soot is produced by moving the support rod from a start point to an end point, while depositing the first bi-layer of soot, then returning to the start point and moving the support rod from the start point to the end point while depositing a second bi-layer of soot, so that the second bi-layer of soot covers the first bi-layer of soot. Additional traverses, forming additional soot layers, may be used also. The second (or third) traverse may be made in either direction, i.e. the support rod may return to the start point and traverse from the start point to the end point of the first pass, or may deposit the additional soot layers on a traverse from the end point back to the start point.

It is also possible, and within the scope of the invention, to form a first bi-layer of soot, followed by a single soot layer, or a single soot layer followed by bi-layer of soot. The invention in these cases may produce a minimum of three layers of different soot compositions. In all of these cases, deposition of the three or more soot layers is completed before any soot layers are consolidated.

Reference to a bi-layer of soot means a first layer of soot with a first soot composition, covered with a second layer of soot, with a second soot composition, to form a bi-layer of soot.

In concluding the detailed description, it should be noted that it will be obvious to those skilled in the art that many variations and modifications may be made to the preferred embodiment without substantial departure from the principles of the present invention. All such variations, modifications and equivalents are intended to be included herein as being within the scope of the present invention, as set forth in the claims.

1. Method comprising the steps of:
a) in a first VAD torch:
i) flowing together a flow of one or more glass precursor gases, and a flow of fuel gas, to form a first soot gas mixture,
ii) igniting the first soot gas mixture to form a first soot flame thereby producing a first glass soot,
b) in a second VAD torch:
i) flowing together a flow of one or more glass precursor gases, and a flow of fuel gas, to form a second soot gas mixture, the second soot gas mixture having a composition different from the composition of the first soot gas mixture,
ii) igniting the second soot gas mixture to form a second soot flame thereby producing a second glass soot,
c) directing the support rod to the first and second VAD torches in tandem, with the first VAD torch preceding the second VAD torch so that the first VAD torch deposits the first glass soot to form a first soot, and the second VAD torch deposits the second glass soot on the first glass soot,
d) moving the support rod relative to the torches from a start point to an end point to produce a first bi-layer of soot,
e) in the first VAD torch:
changing the composition of the one or more glass precursor gases, and a flow of fuel gas, to form a third soot gas mixture, producing a third glass soot,
f) moving the support rod relative to the torches to traverse the first bi-layer of soot while depositing an additional layer of soot,
g) heating the bi-layer of soot and the additional layer of soot to consolidate the soot into a glass preform.

2. The method of claim 1 wherein the additional layer of soot is a bi-layer of soot and the method comprises the additional step of
i) in the second VAD torch:
changing the composition of the one or more glass precursor gases, and a flow of fuel gas, to form a fourth soot gas mixture, to produce a fourth glass soot.

3. The method of claim 1 wherein the first glass soot comprises germanium.

4. The method of claim 1 comprising the additional steps of:
heating the preform to a softening temperature, and
drawing a glass fiber from the preform.

5. The method of claim 2 comprising the additional steps of:
heating the preform to a softening temperature, and
drawing a glass fiber from the preform.

6. Method comprising the steps of:
a) in a first VAD torch:
i) flowing together a flow of one or more glass precursor gases, and a flow of fuel gas, to form a first soot gas mixture,
ii) igniting the first soot gas mixture to form a first soot flame thereby producing a first glass soot,
c) exposing a VAD starting rod to the first VAD torch, so that the first VAD torch deposits the first glass soot in a first soot layer,
d) moving the support rod relative to the torches from a start point to an end point to produce a first layer of soot,
e) in the first VAD torch:
changing the composition of the one or more glass precursor gases, and a flow of fuel gas, to form a second soot gas mixture, to produce a second glass soot,
f) in a second VAD torch:
i) flowing together a flow of one or more glass precursor gases, and a flow of fuel gas, to form a third soot gas mixture, the third soot gas mixture having a composition different from the composition of the second soot gas mixture,
ii) igniting the third soot gas mixture to form a third soot flame thereby producing a third glass soot,
g) moving the support rod relative to the torches to traverse the first layer of soot while depositing on the first layer of soot a bi-layer of a second soot layer and a third soot layer,
h) heating the first second and third soot layers to consolidate the soot into a glass preform.

7. The method of claim 6 comprising the additional steps of:
heating the preform to a softening temperature, and
drawing a glass fiber from the preform.
